(19) United States
(12) Patent Application Publication
(10) Pub. No.: US 2009/0046685 A1
(43) Pub. Date: Feb. 19, 2009

(54) Method and System for a Wireless Transmission over GPRS Communications Network

(76) Inventors: Chen-Hua Chen, Shintien City (TW); Chu-Chiang Lin, Shintien City (TW)

Correspondence Address: SINORICA, LLC, 528 FALLSGROVE DRIVE, ROCKVILLE, MD, 20850, US

(21) Appl. No.: 12/189,214

(22) Filed: Aug. 11, 2008

(30) Foreign Application Priority Data
Aug. 14, 2007 (TW) 96130054

(51) Int. Cl. H04Q 7/20

(52) U.S. Cl. 370/338

(57) ABSTRACT

The present invention provides a system and method of wireless transmission in GPRS communications network, comprising a virtual COM utility program for creating virtual COM ports. A GPRS virtual COM gateway server is coupled to the virtual COM ports via LAN or Internet. A plurality of remote electronic device is coupled to its corresponding GPRS data terminals. Remote electronic devices can connect to GPRS virtual COM gateway server by GPRS data terminals through GPRS network and Internet for wireless transmitting data to the local device.

### FIELD OF THE INVENTION

The present invention relates to the field of wireless communications, more specifically relates to opening a virtual serial communications port over a GPRS wireless communication network. Moreover, the present invention relates to an user interface for selecting a remote electronic device in GPRS wireless communication network for the purposes of communications.

### BACKGROUND OF THE INVENTION

The general packet radio service (GPRS) is a new non-voice value added service that allows information to be sent and received across a mobile telephone network. It supplements circuit switched data and short message service networks. The theoretical maximum speed of GPRS can be up to 171.2 kilobits per second (kbps). This maximum speed can be achieved in GPRS systems by using all of the eight timeslots at the same time in a time division multiple access (TDMA) context.

This maximum speed is about three times faster than the possible data transmission speeds over the wireline telecommunication networks, and ten times faster than the circuit switched data services on the Global System for Mobile Communications (GSM) standard of TDMA networks. The GPRS systems are advantageous in that they require less system resources to transmit a fixed amount of data comparing to the same transmission by using a traditional circuit switched system. By allowing information to be transmitted more quickly, immediately, and efficiently, across the mobile network, GPRS may well be a relatively less costly mobile data service comparing to SMS services and circuit switch data.

One advantage of the GPRS is the packet switching resulting from the infrastructure nodes that allows the use of GPRS radio resources only when users actually sending or receiving data. Unlike traditional circuit switched voice networks, a connection is not continuously reserved for a user for the intermittent data transmission. The efficient use of scarce radio resources leads to more GPRS users sharing the same bandwidth and being served from a single base station (???) or cell. The actual number of users that may use the system at one time depends on the amount of data being transferred.

### SUMMARY OF THE INVENTION

The present invention provides a method and apparatus for opening a virtual serial communications port for establishing a wireless connection over GPRS communications network.

The present invention allows the user to access the data generated or detected from the remote electronic device by connecting GPRS communications network through functioning virtual COM (communication) ports.

The present invention provides a system for a wireless transmission over GPRS communications network, comprising a virtual COM utility to produce virtual COM ports. A GPRS virtual COM port gateway server is coupled to the virtual COM utility program via Internet or LAN (Local Area network). A GPRS module is coupled to the GPRS virtual COM port gateway server via the Internet and the GPRS network for wireless data transmission from a GPRS data terminal. The GPRS data terminal is used for storing and transmitting data. A remote electronic device is coupled to the GPRS data terminal for retrieving or detecting data, and sending the data to the GPRS data terminal for further transmissions.

Another aspect of the present invention discloses a method of establishing a communication path over a GPRS wireless communication network, said method comprising the steps of receiving a request from the virtual COM utility program to open a virtual communication (COM) port in a local electronic device. The following step is selecting one of the currently available remote electronic devices within GPRS wireless communication network and the Internet which are capable of communicating with said electronic device. Then, creating a communication path including the Internet and GPRS network between the selected remote electronic device and said electronic device. Finally, opening virtual COM port for data transfer between the application program and remote electronic device over GPRS wireless communication network.

### BRIEF DESCRIPTION OF THE DRAWING:

For a better understanding of the present invention and to show how it may be implemented, reference will now be made to the following drawings:

FIG. 1 is a schematic diagram of GPRS communication network.

FIG. 2 is a system for a wireless transmission in GPRS communications network of the present invention.

FIG. 3 is a data flow of performing process of the GPRS communications network system according to the present invention.

FIG. 4 is steps of method for establishing a communication path over a GPRS wireless communication network in accordance with one embodiment of the invention.

### DESCRIPTION OF THE PREFERRED EMBODIMENT:

The present invention is described with the preferred embodiments and accompanying drawings. It should be appreciated that all the embodiments are merely used for illustration. The present invention can also be applied to various embodiments other than the preferred embodiments.

In the following detailed description of the present invention, numerous specific details are set forth in order to provide a thorough understanding of the present invention. However, it will be recognized by one of ordinary skilled in the art that the present invention may be practiced without these specific details. Practices, methods, procedures, components, and circuits that are well known to one skilled in the art are not further described in this disclosure.

Some embodiments of the present invention are discussed primarily in a context in which devices and systems are coupled using Internet, wireless links, and specifically with regard to devices and systems compliant with the GPRS technology and virtual COM utility. GPRS provides long-range radio links between personal computers (PCs), GPRS data terminal device and other devices. The virtual COM serial port set up by the virtual COM utility is presented to the user and serial applications at the user level as a fully recognized and initialized serial port. Instead of being connected to a dedicated remote device, the virtual COM serial port is a selected GPRS functional profile and may not necessarily be coupled with a remote electronic device at any particular time.

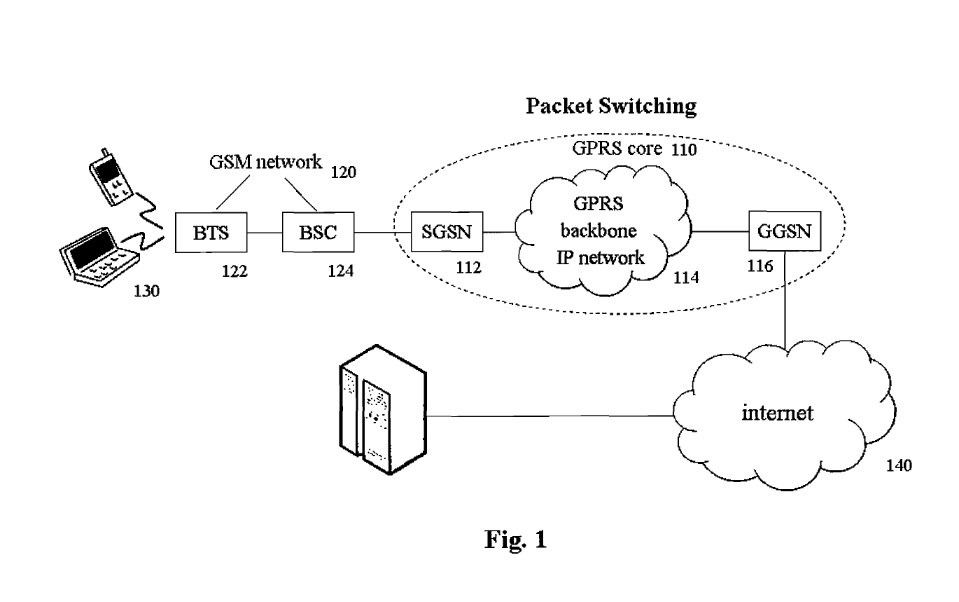

As is illustrated in FIG. 1, generally, GPRS (General Packet Radio Service) is an architecture of integrating digital communication network to the existing GSM network. GPRS network is primarily a GPRS message center (or core) 110, which mainly comprises a SGSN (Serving GPRS Support Node) 112, GPRS intra-PLMN backbone network 114 and a GGSN (Gateway GPRS Support Node) 116. In FIG. 1, BTS (base transceiver station) 122 and BSC (base station controller) 124 are the network sections of former GSM architecture. When a remote device (for example, a cell phone) dials, signals are first connected to BTS 122, then transmitted to the BSC 124. Through the transmitting of BSC 124, the remote device 130 are connected to GPRS center 110. In the GPRS network, SGSN 112 and GGSN 116 both provide the functions of packet handling and packet transferring. The GGSN 116 is a gateway between GPRS network and other external networks, which can transfer the packets from external networks (i.e., the Internet) 140 into GPRS network, or transfer the data packets from the GPRS network to external networks 140. The primary function of SGSN 112 includes: authenticating subscribers of GPRS, recording the BTS 122 of subscribers, and granting dynamic IP addresses to the devices of subscribers, and packaging the data receiving from the GGSN 116 for wirelessly transmitting the data to the remote customer devices 130 through BSC 124 and BTS 122.

The SGSN 112 is coupled to and communicates with a wireless network for delivering Short Message Service (SMS) messages to mobile terminals 130. For example, SGSN 112 is connected to a base station. The wireless network further includes mobile switching centers. Once the base station receives the SMS message for delivery to the mobile terminal, it transmits the message through an antenna in a cell area in which the mobile terminal was last registered for delivery to a mobile terminal 130 over a wireless communication link.

The GGSN 116 includes a plurality of network ports to receive GPRS data packets from the Internet as well as from private data networks, which network ports receive the data packets in accordance with Internet protocol (IP). The GGSN 116 then transmits the data packets via IP to SGSN 112. Thus, SGSN 112 is operable to receive data packets in an IP format for transmission to a mobile terminal by way of the base station.

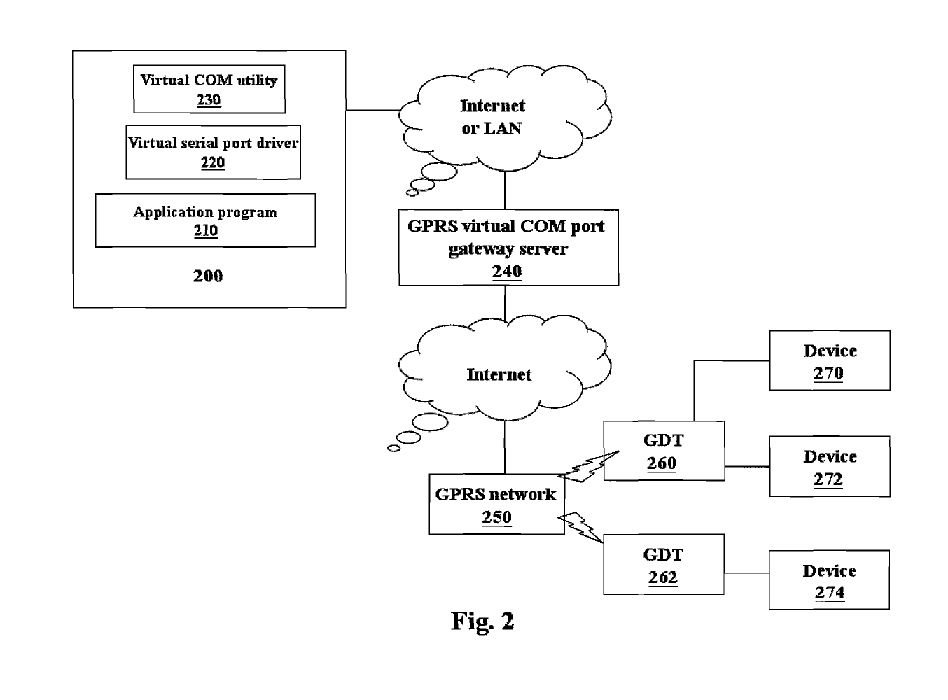

Referring to FIG. 2, which is illustrating a system for a wireless transmission in GPRS communications network. The system comprises a local device 200 having a virtual communications (VCOM) utility program 230, a GPRS virtual COM port gateway server 240, a GPRS signal transmission station 250, GPRS data terminal (GDT) 260, 262 and remote electronic device 270, 272, 274. The virtual communications (VCOM) utility 220 is installed in local device 200. The GPRS signal transmission station 250 in FIG. 2 substantially includes all portions of the GSM network 120 and GPRS center 110 (i.e. BTS 122, BSC 124, SGSN 112, GGSN 116 and GPRS backbone network 114) illustrated in FIG. 1. The virtual COM utility program 230 with wireless capabilities is used to perform the function of opening a VCOM serial port in accordance with embodiments of the present invention.

The present invention utilizes GPRS to facilitate accessing data from remote appliances and machines via Internet applications. It is anticipated that, in the present invention, appliances will be designed to be coupled to the GPRS module for transmitting data to onsite or remotely computer. While connecting these appliances to a network port by physical lines, for example RS232, it would clearly be advantageous to be able to connect such appliances to the Internet through a wireless link. In telecommunications, RS-232 is a standard for serial binary data interconnection between a DTE (Data terminal equipment) and a DCE (Data Circuit-terminating Equipment). In the present invention, GPRS will facilitate the creation of Internet controlled appliance networks through a wireless medium.

With reference to FIG. 2, a method and system which accessing remote data by virtual COM port through GPRS wireless communication network wherein the system comprises computer-readable and computer executable instructions which reside, for example, in media of a computer system.

Mostly, local device 200 is connected to Internet through the virtual communications (VCOM) utility program 230 which is employed to link and monitor the link status and data transmission. The virtual communications (VCOM) utility program 230 may request to create a plurality of virtual COM ports and connect to Internet or LAN. The local device 200 also comprises a virtual serial port driver 220, and an application program 210 installed therein. The application program 210 will utilize the virtual com port set up by virtual serial port drive for responding the data transmission from/to the remote terminal. In one embodiment of the present invention, a plurality of virtual COM serial ports are created and managed by a virtual COM utility program. Each of the virtual COM ports has an corresponding driver 220 for setting up the virtual COM port. In addition, for purposes of setting up a VCOM port, virtual COM utility program will control the communication between GPRS wireless communication protocol stack and the VCOM port in order to facilitate communications over the wireless communication network.

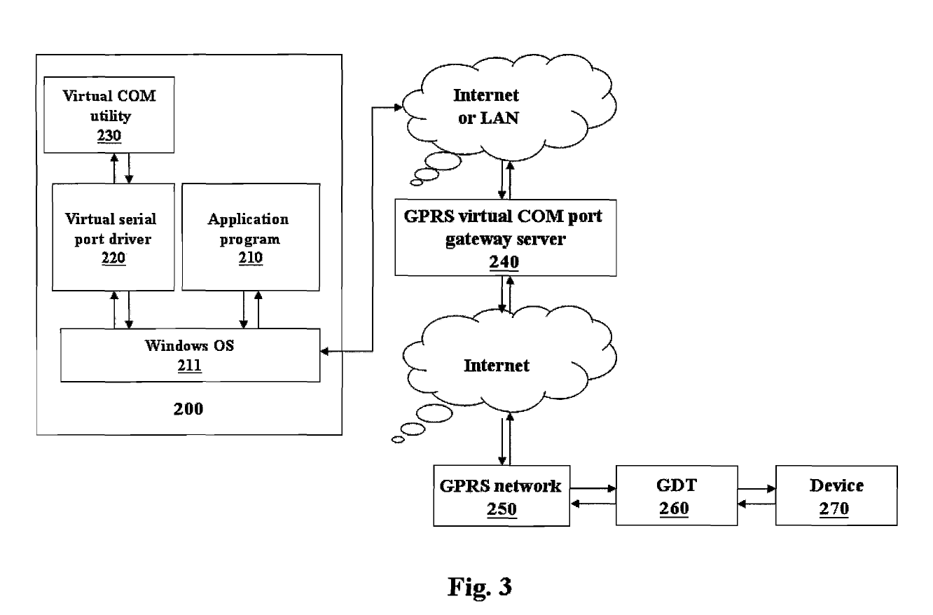

The application program 210 is utilized to assign a specific client device. The virtual serial port driver 220 may be an interface between virtual COM utility program 230 and Windows OS 211 in FIG. 3. In other words, virtual COM utility program 230, for example, a connection manager application helps control the setting up of a virtual COM serial port by an application program 210 for purposes of transferring data over a GPRS communication path. By definition, the application is compatible with the protocol associated with GPRS wireless communication network.

For example, some applications that communicate serially over a serial communication port will not work if their attempt to setting up a virtual COM serial port succeeds before a GPRS wireless connection is established particularly when the application program 210 in a local electronic device 200 attempts to open a communication port. As soon as the setting up of a port succeeds with a successful return back to the application, the application program 210 begins to send modem commands through the virtual COM port. The protocol associated with GPRS wireless communication network may take a little time to establish a connection with a remote device. As such, a DUN (Dial-Up Network) application program will terminate any future modem commands because it senses a failure in the communication path to the remote device. However, the present embodiment suspends the setting up of a virtual COM port until a communication path is established over GPRS communication network between the computer and a remote electronic device within a GPRS network. This allows application compatibility in opening a virtual COM port in a GPRS wireless communication network.

Virtual COM serial port is not associated particularly with a specific hardware device. This is because in a wireless communication network, multiple devices with multiple functionalities or profiles continue to enter and leave the local area network (LAN), or in a GPRS environment, associated with the remote electronic devices 270, 272, 274. Moreover, each initialized serial port is flexibly configured to support a particular profile. This allows a user of the computer (i.e. local device) 200 to select between multiple devices that are currently within its local wireless network, or in a GPRS environment.

Moreover, GPRS virtual COM port gateway server 240 is coupled to computer 200 and GPRS signal transmission station 250 respectively via Internet. GPRS virtual COM port gateway server 240 is available for providing a communication between local device 200 and GPRS signal transmission station 250. GPRS data terminal (GDT) 260, 262 have a GPRS module for connecting GPRS signal transmission station 250 to transfer data. GPRS data terminal 260, 262 are coupled to the remote electronic devices 270, 272 and 274, respectively via RS 232. GPRS data terminals 260, 262 include a processing unit to simulate virtual COM utility 230 action, memory to store data. The remote electronic device may be selected by a user from a list of available devices. In another embodiment, a user may also pre-configure the virtual COM port for a specific functional profile and pre-configure a remote electronic device for the virtual COM port.

One aspect of the present invention, the remote electronic device 270, 272 and 274 could produce data. Therefore, the present invention may perform a data collection and data transmission from remote devices via GPRS wireless network.

FIG. 3 is a data flow of performing process of the GPRS communications network system, wherein includes computer implemented method for opening a virtual COM serial port in accordance with one embodiment of the invention. The fundamental principle of the present embodiment is that a virtual COM utility program 230 will not successfully complete a port-open-attempt until a GPRS wireless connection is established in a GPRS wireless communication network. This ensures that the application will be able to communicate with a remote electronic device over a GPRS wireless communication network.

The present embodiment, the first step of opening a virtual COM serial port begins by sending an attempt-to-open request from an virtual COM utility program 230 to a virtual COM serial port driver 220 (as an interface based-on Windows OS 211). Windows OS 211 with an Internet module is available for connecting the Internet. The virtual COM port driver 220 does not immediately complete the attempt-to-open request. The present embodiment provides a virtual COM utility 230 to notify the GPRS protocol stack of the attempt-to-open request from GPRS virtual COM port gateway server 240 to GPRS network 250 via the Internet. This effectively suspending attempt-to-open operation as the application is waiting for a return status on the request such as, successful, or unsuccessful, or error. Next, the present embodiment establishes a communication path or connection between the local electronic device 200 and the remote electronic device 270 over GPRS wireless communication network. The remote device 270 can be selected by prompting the user to select.

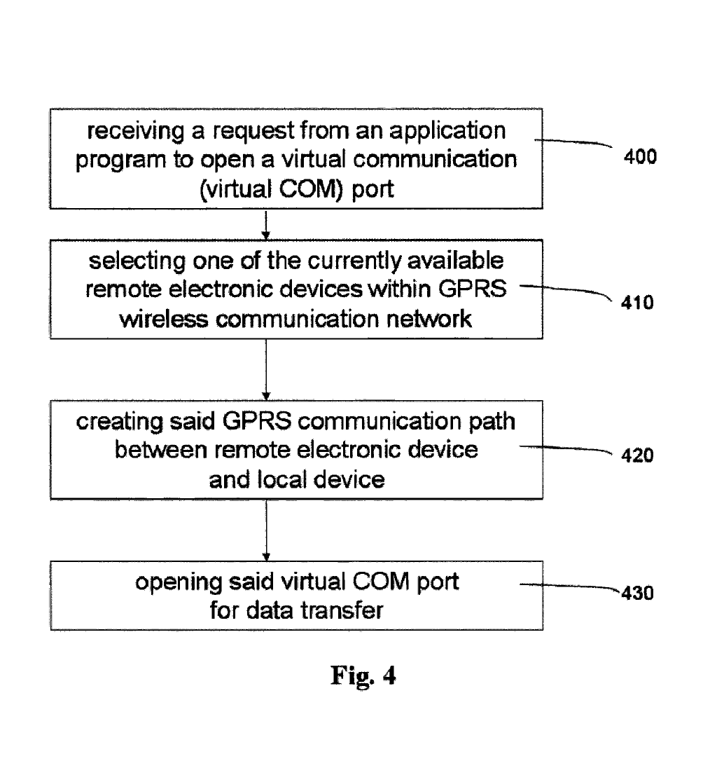

Referring to FIG. 4, which illustrates a method of establishing a communication path over a GPRS wireless communication network in accordance with one embodiment of the present invention. Firstly, receiving a request from an application program to open a virtual COM port in a first electronic device is performed in the step 400. Next, in the step 410, it selects one of the currently available remote electronic devices within GPRS wireless communication network that are capable of communicating with the first electronic device. Subsequently, creating GPRS communication path between the remote electronic device and local electronic device is performed in the step 420. Finally, opening virtual COM port for data transfer between the application and remote electronic device over GPRS wireless communication network is performed in the step 430.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

We claim:

1. A system for a wireless transmission over GPRS communications network, comprising: a virtual COM utility program in a local communication device to produce virtual COM ports for selecting at least one desired remote device to connect; a first GPRS module coupled to a GPRS gateway server via an Internet for wireless data transmission;
at least one GPRS data terminal (GDT) for storing and transmitting remote data, said GPRS data terminal is coupled to said local communication device via GPRS network and Internet; and
at least one remote electronic device coupled to said GPRS data terminal for detecting or collecting data from said remote device.

2. The system as set forth in claim 1, further comprising a GPRS virtual COM port gateway server.

3. The system as set forth in claim 1, further comprising a virtual serial port driver coupled to said virtual COM utility program in local communication device for opening a virtual COM port.

4. The system as set forth in claim 1, further comprising an application program coupled to said virtual COM utility program.

5. The system as set forth in claim 1, wherein a GPRS signal transmission station is coupled to said at least one GPRS data terminal.

6. The system as set forth in claim 1, wherein said GPRS data terminal is coupled to said at least one remote electronic device via RS 232.

7. The system as set forth in claim 1, wherein said GPRS data terminal (GDT) includes a processing unit.

8. A method for establishing a communication path over a GPRS wireless communication network, said method comprising the steps:
receiving a request from an application program to open a virtual COM port in a local electronic device;
selecting one of currently existing remote electronic devices within said GPRS wireless communication network that are capable of communicating with said local electronic device;
creating said GPRS communication path between said remote electronic device and a first electronic device; and
opening said virtual COM port for accessing data from said remote electronic device over said GPRS wireless communication network and Internet.

9. The method of claim 8, wherein said virtual COM port is opened by a virtual COM driver.

10. The method of claim 8, further comprising providing a GPRS data terminal (GDT) coupled to said GPRS wireless communication network and said remote electronic device.

11. The method as set forth in claim 8, wherein said GPRS data terminal is coupled to said remote electronic device via RS 232.
